(19) United States
(12) Patent Application Publication
(10) Pub. No.: US 2016/0343276 A1
(43) Pub. Date: Nov. 24, 2016

(54) USE OF A CODE FOR MARKING A NACELLE

(71) Applicant: AIRCELLE, Gonfreville L'orcher (FR)

(72) Inventors: Serge EPHERRE-IRIART, LE HAVRE (FR); Eric LECOSSAIS, VIRVILLE (FR); Jerome VILLION, LE HAVRE (FR); Thierry DEFRESNE, SAINT SANSON DE LA ROQUE (FR)

(73) Assignee: AIRCELLE, GONFREVILLE L'ORCHER (FR)

(21) Appl. No.: 15/229,385

(22) Filed: Aug. 5, 2016

Related U.S. Application Data
(63) Continuation of application No. PCT/FR2015/050288, filed on Feb. 6, 2015.

(30) Foreign Application Priority Data
Feb. 6, 2014 (FR) 14/50920

(51) Int. Cl. G09F 3/00; G06K 7/14; G06K 7/10; B64C 7/02; B64F 5/00

(52) U.S. Cl. CPC G09F 3/0297; B64C 7/02; B64F 5/00; G06K 7/10366; G06K 7/1413; G06K 7/1417

(57) ABSTRACT

An automatic identification device is provided on a surface of a nacelle of an aircraft, the device containing at least one element of information allowing access to a base of technical resources relating to the nacelle.

### CROSS-REFERENCE TO RELATED APPLICATIONS

This application is a continuation of International Application No. PCT/FR2015/050288, filed on Feb. 6, 2015, which claims the benefit of FR 14/50920 filed on Feb. 6, 2014. The disclosures of the above applications are incorporated herein by reference.

### FIELD

The present disclosure concerns the use of identification devices such as external markings of aircraft nacelles in particular to assist in the maintenance of such aircraft nacelles.

### BACKGROUND

The statements in this section merely provide background information related to the present disclosure and may not constitute prior art.

Inadvertent errors in the maintenance of aircraft and in particular aircraft nacelles may generate incidents on airlines. Indeed, the maintenance operators can perform maintenance operations not adapted to a given nacelle, as well as online in order to perform routine and light maintenance operations in a workshop in order to perform heavy maintenance operations, in particular due to the fact that there are several types and models of nacelles which are sometimes difficult to distinguish from each other and that some maintenance operations adapted to a given nacelle are not for another nacelle.

The number of these errors should be reduced in order to make more reliable, facilitate and accelerate the maintenance operations, to better secure flights and thus to reduce the operating costs of the airlines.

### SUMMARY

The present disclosure relates to an aircraft nacelle noteworthy in that it includes an automatic identification device present on a surface of the nacelle containing at least some information enabling access to a technical resources base (e.g., database) relating to the nacelle.

Automatic identification device means a device code which may be read by an active electronic device such as a smartphone or other adapted instrument, for example, a QR code.

It is then possible using a tablet, a smartphone or any other adapted instrument, to access to the maintenance resources base specific to a given nacelle equipped with an automatic identification device without the users having to determine beforehand the nacelle type to be maintained, thus reducing the risks of errors during the maintenance of the nacelle.

The use of automatic identification devices on aircraft nacelles by one or more user(s) also allows faster access to the desired information, facilitating and thus accelerating the work to be performed on the nacelles.

According to other features of the present disclosure, the nacelle includes one or more of the following optional features considered alone or in any possible combination:
the technical resources base relating to the nacelle may be a resources base relating to the maintenance of the nacelle, the users are then maintenance operators,
the automatic identification device may be in the form of a sticker, such as those commonly used in aeronautics to withstand the environmental conditions,
the automatic identification device may be varnished to increase its resistance to the environmental conditions,
the automatic identification device may be located on an inner surface, not visible from the outside of the nacelle,
the automatic identification device is located on an easily visible surface of the nacelle by a user, for example on an outer surface of the nacelle in the lower portion of the nacelle,
the automatic identification device is located on an accessible surface of the nacelle by a user, for example on an outer surface of the nacelle in the lower portion of the nacelle,
the automatic identification device is an RFID chip,
the automatic identification device may be a code of the scan code type,
the scan code is in the form of a transfer,
in the case where the scan code is visible on a painted surface of the nacelle, the scan code may be directly painted on the surface,
the scan code may be directly painted on the surface at the moment of painting the surface so that the scan code is at the same level as the rest of the paint from the painted surface, this being in particular advantageous in the case where the painted surface is a faired surface,
the scan code may be a QR code,
the scan code may be a tag, for example a Bleam® Tag, from the Ubleam® company,
the scan code may be a 2D bar code,
the scan code may be a 3D barcode.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective view of a nacelle on which a QR code is disposed.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

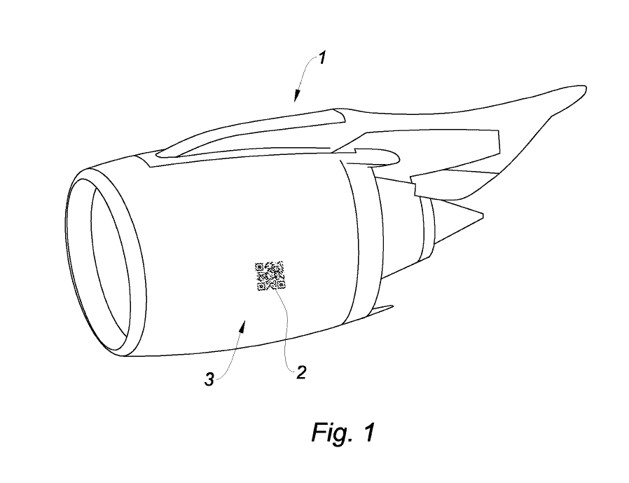

Referring to FIG. 1, there is described a turbojet engine nacelle 1 on which a QR code 2 is disposed on a surface 3.

According to a one form of the present disclosure, the QR code 2 is painted onto a visible surface 3 and easily accessible by a maintenance operator so that the operator can easily get an optical sensor mounted on a smartphone or a tablet in front of the QR code 2 and thus easily and quickly access to maintenance information specific to the nacelle 1 with the QR code 2, the identification of the nacelle 1 is thus made more reliable.

Depending on the type of maintenance to be performed on the nacelle 1, the maintenance operator can be an online workshop maintenance operator, respectively to carry out light or heavy maintenance operations.

Other data than the maintenance data may be accessible through this QR code 2, such as price catalogs on the components of the nacelle 1 so that the operators immediately know the cost of the maintenance parts.

In any case, the data accessible through the QR code 2 may be in different formats, for example in the form of as text files, images, sounds, videos or any other known and adapted digital format allowing, in particular arranging, for example, maintenance tutorials allowing, for example, simplifying the training of the maintenance operators.

It goes without saying that the QR codes which do only refer to data interesting only for the maintenance operators, but may also make reference to other data interesting, for example, specifically for the designers of nacelles, manufacturers of nacelles or any person interested in a step of the life cycle of a nacelle 1.

In their operation, the QR codes preferably refer to secure Intranet sites.

It goes without saying that the invention is not limited to the form described hereinabove by way of an example, but it comprises all technical equivalents and all the variants of the described means as well as the possible combinations thereof.

What is claimed is:

1. An aircraft nacelle including an automatic identification device present on a surface of the nacelle containing at least one piece of information enabling access to a technical resources base relating to the nacelle, wherein the automatic identification device is a code of the scan code type painted on the surface.

2. The nacelle according to claim 1, wherein the technical resources base relating to the nacelle is a resources base relating to the maintenance of the nacelle.

3. The nacelle according to claim 1, wherein the automatic identification device may be covered with a varnish layer.

4. The nacelle according to claim 1, wherein the automatic identification device is located on an inner surface not visible from the outside of the nacelle.

5. The nacelle according to claim 1, wherein the surface is a painted faired surface.

6. The nacelle according to claim 5, wherein the scan code is painted directly onto the surface at the moment of painting of the surface so that the scan code is at a same level as paint of the painted faired surface.

7. The nacelle according to claim 1, wherein the scan code is a QR code.

8. The nacelle according to claim 1, wherein the scan code is a tag.

9. The nacelle according to claim 1, wherein the scan code is a barcode.
